(19) United States
(12) Patent Application Publication
(10) Pub. No.: US 2011/0170988 A1
(43) Pub. Date: Jul. 14, 2011

(54) CARGO TRANSFER SYSTEM

(75) Inventors: Michael John Perry, Singapore (SG); Rune Henriksen, Norway (SG); Kok Seng Foo, Singapore (SG); Asbjorn Mortensen, Singapore (SG); Wen Sin Chong, Singapore (SG); Dhivakar Poosapadi, Singapore (SG)

(73) Assignee: KEPPEL OFFSHORE & MARINE TECHNOLOGY CENTRE PTE LTD, Singapore (SG)

(21) Appl. No.: 13/119,617

(22) PCT Filed: Sep. 16, 2009
(86) PCT No.: PCT/SG2009/000343

§ 371 Date: Mar. 17, 2011

Related U.S. Application Data
(60) Provisional application No. 61/098,426, filed on Sep. 19, 2008.

(51) Int. Cl. B63B 27/30; B66C 23/52; B65G 67/60

(52) U.S. Cl. 414/138.2; 414/803

(57) ABSTRACT

A cargo transfer system for transferring cargo between two decks which may be subject to relative movements between each other is disclosed. The cargo transfer system includes a transverse member movably coupled to an elevated portion of a first deck (or a tower member on the first deck), and a side member movably coupled to the transverse member. In a deployment position, the side member is releasably coupled with a receiving base on the second deck. The cargo transfer system is actuatable by a relative movement between the first deck and the second deck to self-adjust for accommodating or countering the relative movement.

### BACKGROUND

1. Technical Field

Embodiments of the invention relate generally to a cargo transfer system, and more particularly, to a system adapted to effect transfer of cargo between platforms and/or vessels which may be subject to relative movements between each other.

2. Description of Related Art

FIG. 1 shows a conventional crane system for transferring cargo containers between a platform and a water traveling vessel. The platforms may be offshore platforms or mobile offshore bases. Due to unpredictability of sea state conditions, the platform and vessel often experience undesirable wave-induced dynamic motions that impede operations for transferring containers therebetween. Relative motions of the platform and the vessel present considerable difficulties to container placement at the destination. Even with careful manipulation of the crane system, relative motion between the vessel and a crane tip caused by wave motions may result in uncontrolled large impacts to the destination deck and adjacent containers on the destination deck during container placement. These uncontrolled impacts may lead to damage of the containers and contents therein. As the propensity of such uncontrolled impacts limits the availability and speed of cargo transfer, improved cargo transfer systems are highly desired.

U.S. Pat. No. 4,632,622 discloses an apparatus for transferring cargo between first and second bodies which are movable relative to each other where a hoist for raising and lowering cargo through a hoist line is mounted on one of the bodies includes a linkage for connecting the two bodies. The linkage is pivotally connected to the bodies for accommodating relative movement between the bodies. A guide is located between the hoist line and one of the bodies for engaging and guiding the hoist line. A trolley which is movable along at least a portion of the linkage engages the hoist line on the side opposite the guide and moves the hoist line along the linkage between the guide and the other body while the line changes length so that cargo connected to the hoist line can be moved along the linkage. The linkage includes a plurality of arms in addition to hydraulic cylinders useful for compensating motion between an articulated connector and a second body.

### SUMMARY

Embodiments of the invention provide a cargo transfer system for transfer of cargo between different decks or bodies, where the cargo transfer system is actuatable (or may be referred to as “capable of being actuated”) by a relative movement between different bodies or decks to self-adjust for accommodating the relative movement. The cargo transfer system may also accommodate changes in relative mean positions between different decks by adjusting or repositioning a location of an effective coupling position between the cargo transfer system and one of the decks.

According to one embodiment, a cargo transfer system comprises a transverse member movably coupled to a first location of a first deck, and a side member disposed below the transverse member. The side member includes a first end movably coupled to the transverse member, and a second end operable to movably couple to the second deck. The cargo transfer system further comprises a carriage movable along the transverse member for transferring a cargo from the first deck to the second deck, or vice versa. At least one of the transverse member and the side member is actuatable by a relative movement between the first deck and the second deck to self-adjust for accommodating the relative movement.

Further, a receiving base may be mounted on the second deck for providing a plurality of connectable positions for accommodating a plurality of relative mean positions (or relative heights) between the first deck and the second deck. A location of an effective coupling between the second end of the side member and the second deck is adjustable or repositionable between the plurality of connectable positions for accommodating a change in a relative mean position between the first deck and the second deck.

In one embodiment, the first location of the first deck may be an elevated portion of the first deck. In another embodiment, the elevated portion may be a tower member mounted on the first deck or an integral portion of the first deck.

### BRIEF DESCRIPTION OF THE DRAWINGS

Embodiments of the invention are disclosed hereinafter with reference to the drawings, in which:

FIG. 1 illustrates a conventional crane system for cargo transfer;

FIG. 2 illustrates two cargo transfer systems in a deployment position according to one embodiment of the invention;

FIG. 3 is a magnified view of the system of FIG. 2;

FIG. 4 shows a possible stowage position for the system of FIG. 3;

FIG. 5 is a side view of a cargo transfer system transferring a cargo container;

FIG. 6 illustrates a rotatable connector of the system of FIG. 3;

FIG. 7 illustrates a side member movably coupled to a receiving base on a second deck;

FIG. 8 illustrates a damping platform provided on a deck for supporting a cargo container;

FIG. 9 illustrates a cargo container supported on a damping platform;

FIGS. 10A to 10D illustrate a vertical damping system and a horizontal damping and guiding system;

FIGS. 11A and 11B illustrate a possible adjustment at the receiving base for accommodating a change in a relative mean position between a first deck and a second deck;

FIGS. 12A and 12B illustrate a self-adjustment in a cargo transfer system which is actuatable by a relative surge movement;

FIGS. 13A and 13B illustrate a self-adjustment in a cargo transfer system which is actuatable by a relative sway movement;

FIGS. 14A and 14B illustrate a self-adjustment in a cargo transfer system which is actuatable by a relative heave motion;

FIG. 15 illustrates a cargo transfer system according to one embodiment of the invention whereby a cargo container is supported by two transverse arms; and

FIG. 16 illustrates one embodiment of the system where a transverse member is movably coupled directly to the first deck.

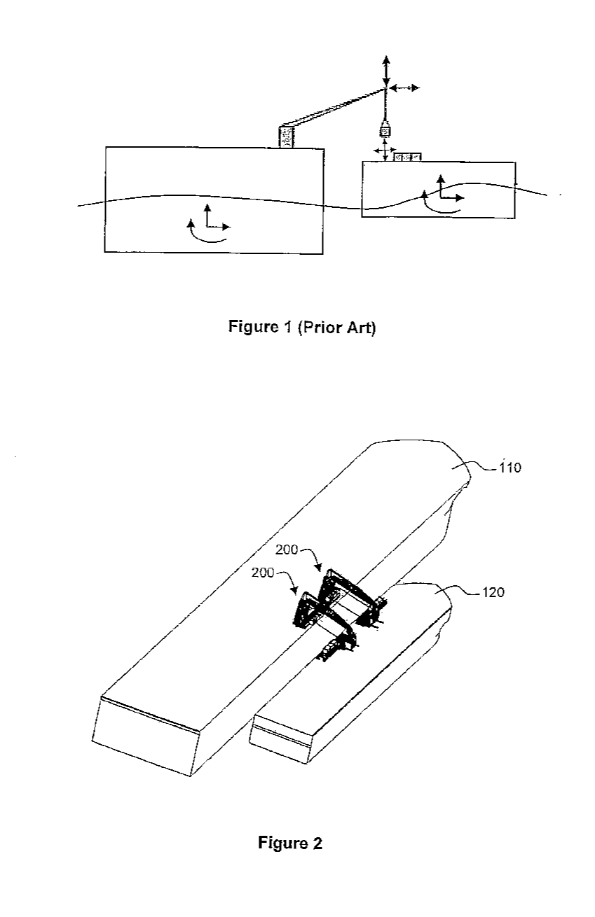

### DETAILED DESCRIPTION

In the following description, numerous specific details are set forth in order to provide a thorough understanding of various illustrative embodiments of the invention. It will be understood, however, to one skilled in the art, that embodiments of the invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

Embodiments of the invention provide a system for effecting transfer of cargo between two decks which may be subject to a relative movement between each other. The decks may be located on a same body or on different bodies. Where transfer of cargo is desired between two bodies, the decks may be located on a stationary body and a moving body; or on two moving bodies. In offshore applications, examples of moving bodies include, but are not limited to, Floating Production, Storage and Offloading vessel (FPSO) and container vessel. Examples of stationary bodies include, but are not limited to, a container port and an offshore fixed platform.

In the following paragraphs, embodiments of the invention are described with reference to transfer of cargo containers between floating bodies, e.g. a floating platform and a container vessel, in an offshore setting for illustrative purposes only. The cargo transfer system is described as being installed on the stationary body or floating platform. However, it is to be understood that certain variations and/or modifications may be applied without departing from the spirit of the invention. For example, the invention may be used in offshore applications as well as in onshore applications; cargo may be provided in containers, tanks, pellets, or other configurations; cargo may include personnel.

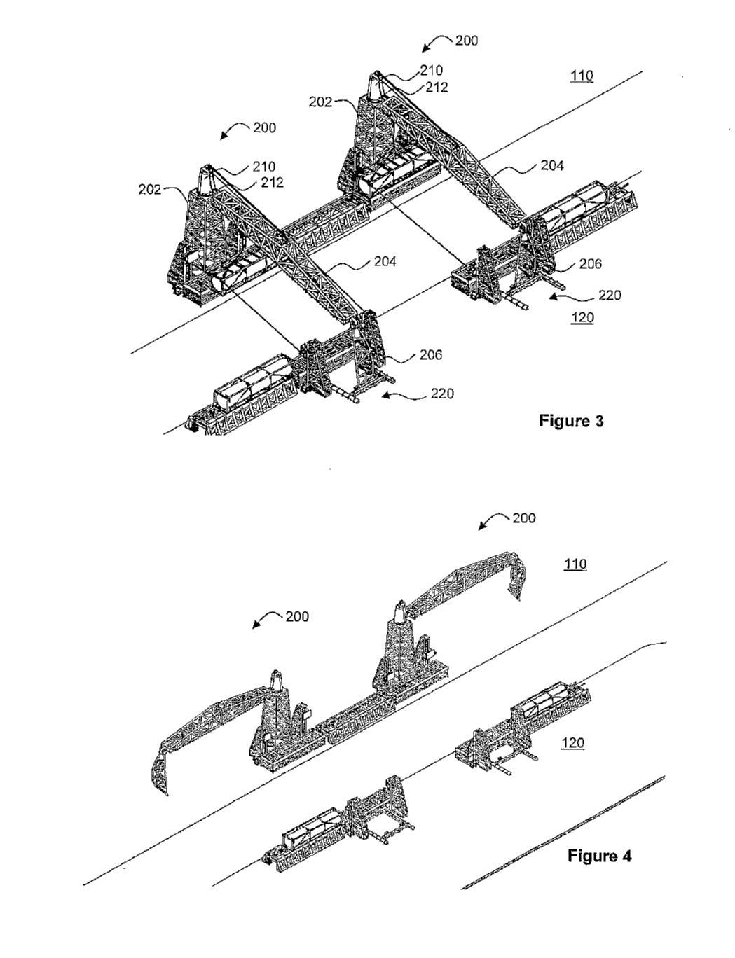

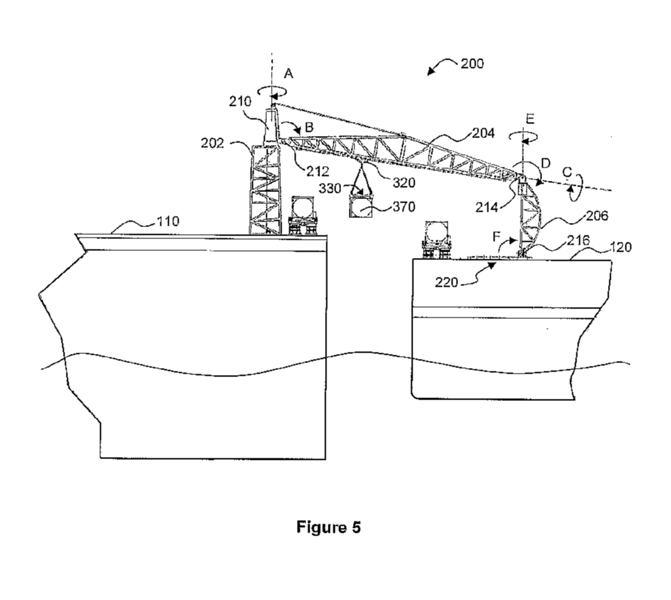

Reference is made to FIG. 2 illustrating two units of cargo transfer system 200 for transferring cargo between a floating platform (hereinafter also referred to as a first deck 110) and a container or carrier vessel (hereinafter also referred to as a second deck 120) in accordance with one embodiment of the invention. A magnified perspective view and a side view of the cargo transfer system are respectively shown in FIGS. 3 and 5. While FIGS. 2 to 4 show two units of cargo transfer systems 200, it is to be understood that a single transfer system or multiple transfer systems may be deployed depending on requirements.

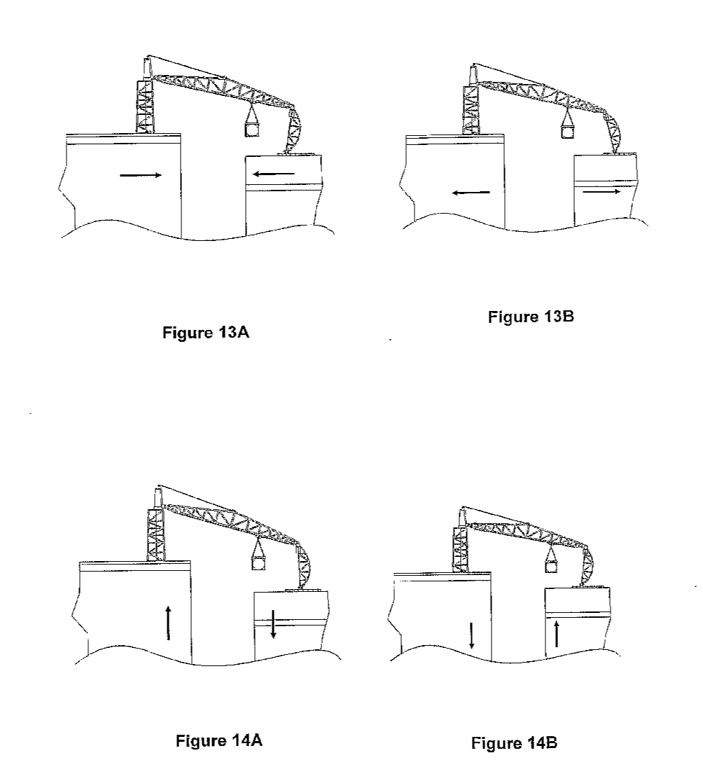

In one embodiment (e.g. FIGS. 2 to 15), a cargo transfer system 200 comprises three primary members or arms: a tower member 202, a main transfer member (or a transverse member 204) and a side member 206. The primary members may be formed of steel or any other suitable materials.

The tower member 202, as depicted in FIGS. 3 to 5, may be mounted or secured at its base to the first deck 110. The tower member 202 is suitably dimensioned and arranged to provide a stabilization structure from which the transverse member 204 and side member 206 coupled thereto may be manipulated. The tower member 202 may also provide an elevation from the first deck 110 where the cargo may be disposed before or after transfer. Accordingly, it is to be appreciated that the tower member 202 may alternatively be an elevated portion of the first deck 110 where the elevated portion may be an integral part of the structure of the first deck 110, or may be a separate structure mounted or formed on the first deck 110.

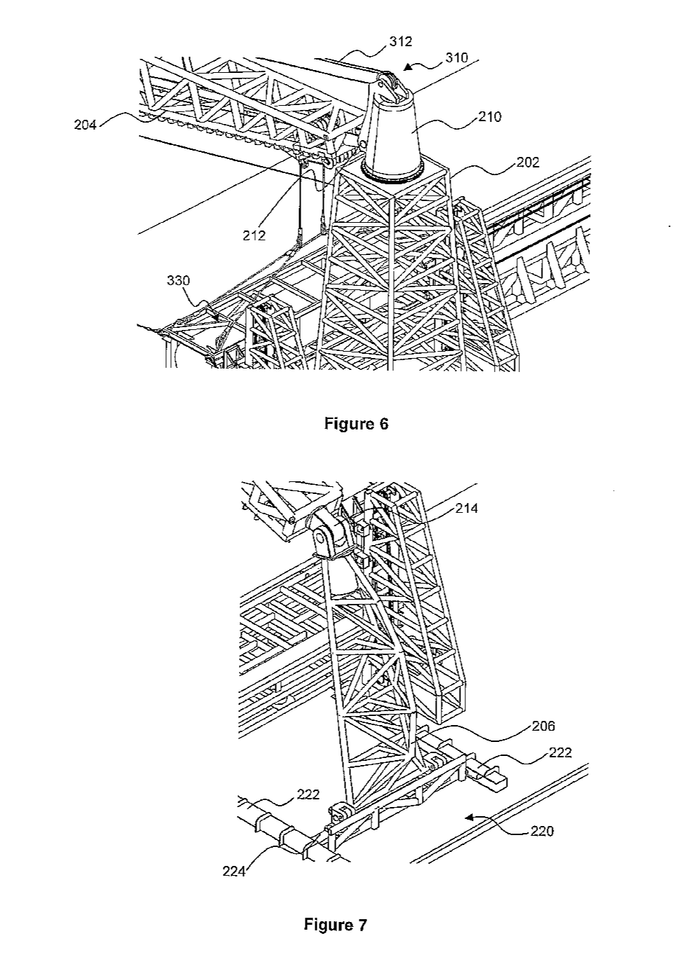

At a top end of the tower member 202, the transverse member 204 is movably coupled thereto, such as, by a rotatable connector 210 and/or a pivotable connector. FIG. 6 illustrates a rotatable connector 210 which is formed of a turntable, a drive assembly or any suitable mechanisms for manipulating the transverse member 204 about a longitudinal axis of the tower member 202 (see arrow A in FIG. 5). The rotatable connector 210 facilitates movement of the transverse member 204 from a stowed position (FIG. 4) to a deployment position (FIG. 3), or vice versa, including any intermediate positions therebetween. The rotatable connector 210 also allows the system 200 to self-adjust in response to certain relative movements between the first deck 110 and the second deck 120. In certain embodiments, the rotatable connector 210 may be appropriately configured to allow manipulation of the transverse member 204 through an angle of up to approximately 180° about the longitudinal axis of the tower member 202. In certain other embodiments, where required, the rotatable connector 210 may be appropriately configured to allow manipulation of the transverse member 204 through an angle of up to approximately 360° about the longitudinal axis of the tower member 202.

A first pivotable connector 212 may be provided to movably couple the transverse member 204 to the tower member 202. This would allow pivotal movement of the transverse member 204 in a vertical plane (i.e. perpendicular to the deck of the platform, see arrow B in FIG. 5). The first pivotable connector 212 may be provided at the rotatable connector 210, for example. In certain embodiments, the first pivotable connector 212 may allow pivotal movement of the transverse member 204 relative to the tower member 202 by an angle of up to approximately 180°.

It is to be appreciated from the foregoing that the rotatable connector 210 and the first pivotable connector 212 would provide the system with two degrees of freedom (DOF) (see arrow A and arrow B in FIG. 5).

For the purposes of manipulating the transverse member 204 between a stowed position (FIG. 4) and a deployment position (FIG. 3), including any intermediate positions therebetween, a pulley system 310 may be provided. The pulley system 310 may include a lifting cable 312 that is guided by a winch supported on the rotatable connector 210 or by a winch located on a first deck 110. The lifting cable 312 extends generally from the rotatable connector 210 to an intermediate point on the transverse member 204. To move the transverse member 204 and side member 206 from a stowed position to a deployment position, the lifting cable 312 may, for example, lift the transverse member 204 together with the side member 206. Auxiliary deck crane, or a drive assembly or a suitable actuation system may move or rotate the transverse member 204 and side member 206 into a deployment position to position the side member 206 over an appropriate location, e.g. a receiving base 220, on the second deck 120. After coupling the side member 206 to the receiving base 220, the lifting cable 312 may then be slackened so that the transverse member 204 is able to self-adjust in response to relative movements between the first deck 110 and the second deck 120. As and when required to move the transverse member 204 and side member 206 from a deployment position to a stowed position, suitable modifications may be made to the above.

A second pivotable connector 214 may be provided to movably couple the transverse member 204 to the side member 206. FIGS. 7 and 8 illustrate a second pivotable connector 214 provided at one end of the transverse member 204 to couple the side member 206 to the transverse member 204. The second pivotable connector 214 would allow relative pivotal movements between the transverse member 204 and side member 206 as and when required (see arrow D in FIG. 5). In certain embodiments, a pivoting angle of the transverse member 204 and side member 206 may extend between approximately 30° to approximately 150°. It is to be appreciated from the foregoing that the second pivotable connector 214 would provide the system 200 with one additional degree of freedom (DOF).

A receiving base 220 may be mounted on the second deck 120 for receiving the side member 206 in a deployment position. The receiving base 220 provides multiple connectable positions over the second deck 120 in a horizontal plane and/or vertical plane. In a deployment position, the side member 206 is movably coupled to the receiving base 220 and assumes one of the connectable positions. Accordingly, a location of an effective connection between the side member 206 and the receiving base 220 may be adjustable or repositionable vertically and/or horizontally by assuming one of the connectable positions for accommodating changes in relative deck location and/or elevation of the first deck 110 and the second deck 120 (or in relative mean position between the first deck 110 and the second deck 120).

FIGS. 7 and 8 illustrate one example of a receiving base 220, which may comprise a pair of guideways 222 (e.g. rail guides or sliding guides) and a movable member 224 which is adjustable along the guideways 222 to allow the movable member 224 assume one of the connectable positions between the ends of the guideways 222. In a deployment position, the side member 206 may be releasably coupled to the movable member 224. For this purpose, an engagement mechanism may be provided at a free or second end of the side member 206 and/or at the movable member 224 of the receiving base 220. The engagement mechanism may allow quick and easy coupling and release. This would be useful when, for example, relative movements between the decks become unacceptably large to be safely handled by the system (or exceed a predetermined level) such that there is a need to quickly disengage or release the side member 206 from the second deck 120.

While FIG. 7 illustrates a horizontal adjustment of the movable member 224, in certain other embodiments, the guideways 222 may be arranged vertically or inclined to better adjust for a range of static or relative mean positions of the two decks envisioned for a particular application. Additionally, the sliding adjustment as illustrated in FIG. 7 may be replaced by a set of fixed connection points or any other system in which a location of an effective connection between the side member 206 and the second deck 120 may be periodically adjusted. A lock mechanism may be provided to secure the movable member 224 at one of the connectable positions during container transfer to ensure safe and stable transfer operation.

A third pivotable connector 216 may be provided to movably couple the side member 206 with the receiving base 220. The third pivotable connector 216 may be provided at the free or second end of the side member 206. The third pivotable connector 216 would allow relative pivotal movements between the side member 206 and the receiving base 220 on the second deck 120 as and when required (see arrow F in FIG. 5). It is to be appreciated from the foregoing that the third pivotable connector 216 would provide the system 200 with one additional degree of freedom (DOF).

Further, the side member 206 may be rotatable about a longitudinal axis of the transverse member 204 to provide the system with one additional degree of freedom (DOF) (see arrow C in FIG. 5). Yet further, the transverse member 204 may also be rotatable about a longitudinal axis of the side member 206 to provide the system with one additional degree of freedom (DOF) (see arrow E in FIG. 5). With the movable connections as described above, a cargo transfer system 200 is capable of having six independent DOF of motion. However, it is to be understood that less than the above-mentioned six independent DOF may be provided in certain applications. In a deployment position, sea and wind conditions induce a relative movement between the first deck 110 and the second deck 120 which actuates the cargo transfer system 200, more particularly at least one of the transverse member 202 and side member 204, to self-adjust for accommodating the relative movement.

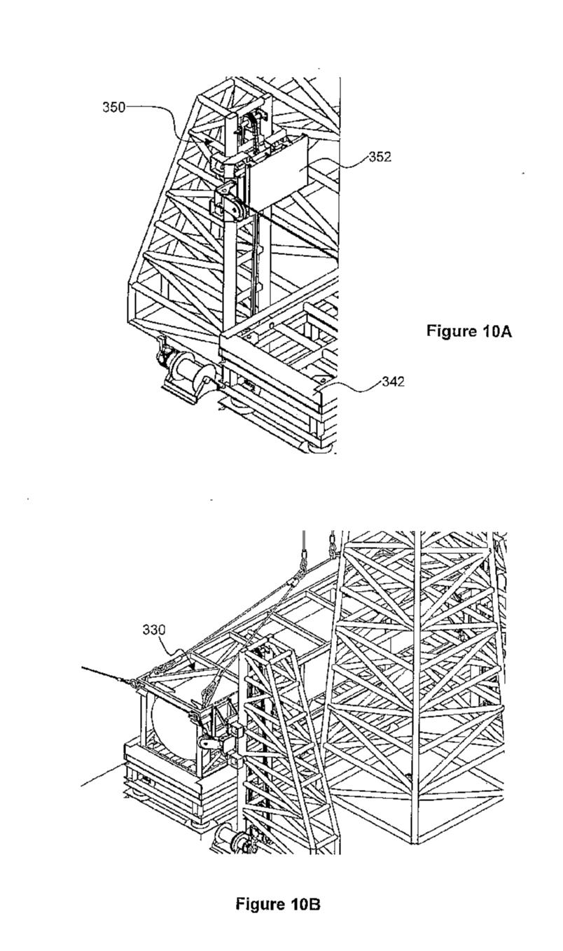

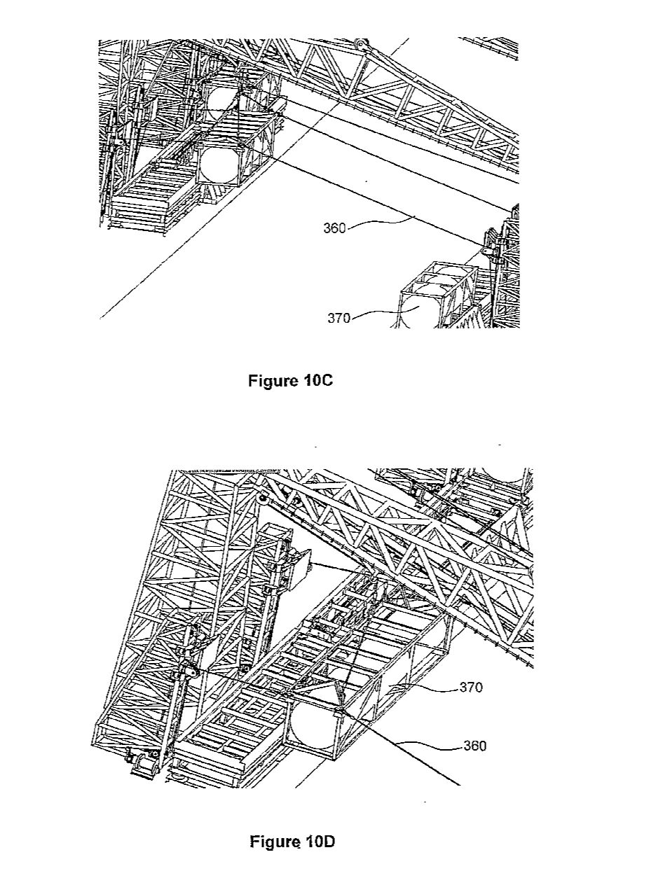

The cargo transfer system 200 may further comprise a carriage 320 for supporting a cargo connector device 330 which is to attach to a cargo container 370. The carriage 320 may be provided at the transverse member 204 and movable along the length of the transverse member 204 to transfer the cargo container 370 supported by the cargo connector device 330 from a first deck 110 to the second deck 120, or vice versa. The carriage 320 may be driven using chain drive systems, cable system or any other known mechanisms. The cargo connector device 330 (see FIGS. 10B and 10C) may comprise a rectangular frame in which slot-shaped locking openings may be provided at each of the four corners of the rectangular frame to receive connecting lags of a cargo container 370. The connecting lags are located at the corner fittings on a top surface of the cargo container 370. Both the slot-shaped locking openings and connecting lags may be formed of steel or other suitable material. To lift a cargo container 370 using the cargo connector device 330, the connecting lags may be rotatably connected to the slot-shaped locking openings of the frame. The connecting lags may be rotated in steps of 90°, for example from a neutral position to a locking position and vice versa. In this case, the connecting lags may be rotated to the locking position to securely connect the cargo container 370 to the frame. The reverse procedure may be performed to release the cargo connector device 330 from the cargo container. In addition, the cargo connector device 330 may also be easily decoupled from the carriage 320 to permit use of an alternative connector device for lifting different sizes of containers that are within the acceptable handling capability of the system. While the foregoing procedure is described with reference to ISO couplers, it is to be understood that other connector systems may be used in embodiments of the invention with suitable modifications.

The cargo transfer system 200 may further comprise a vertical damping system or platform to reduce impact on a cargo container upon onloading (lifting from an origin deck) and offloading (placing on a destination deck), and a horizontal damping and guiding system (also referred to as a catch-and-guide system) for restricting undesirable lateral movements or swinging of the cargo container during onloading and offloading.

In FIGS. 10A to 10D, a set of vertical damping system and a horizontal damping and guiding system 350 is installed on each of the first 110 and the second deck 120 and located on the lateral sides of the tower member 202 and the side member 206 where a cargo container is to be onloaded and offloaded. The vertical damping system may include damping platforms 342 operated by a pneumatic, electro-hydraulic or other appropriate mechanism. Further, damping pads or air-cushioned devices (e.g. air springs) may be provided to absorb the landing impact of a cargo container 370 when placed on the damping platform 342. A movable guide 352 may be provided to restrict lateral or swinging movements of a cargo container 370 as it is being lifted from or lowered onto a damping platform. The damping pads may minimize the impact forces exerted by the cargo container before the cargo container 370 is lowered to the damping platform. In addition, the damping platform 342 may also be installed with actuator systems or roller to move the cargo containers 370 to and from the damping platform. Additionally, a control subsystem may be installed to reduce the forces acting on the cargo container 370 during the transfer. The control subsystem may enable the carriage 320 to reposition relative to the second deck 120 in response to relative movements between the carriage 320 and the second deck 120.

The cargo transfer system 200 may further include a tag-line system 360 in which tag lines are (permanently or removably) connected to the lateral sides of the cargo connector device 330. Adjustment of the tag lines may be performed using winches. During transfer of a cargo container 370 from a first deck 110 to a second deck 120 (or vice versa), the tag lines may be appropriately adjusted using a constant tension system or other appropriate system. In this manner, the tag lines may assist in damping any swinging motions that might occur during the transfer and thereby substantially restricting major pendulum movements of the cargo container 370.

Dimensions of the cargo transfer system 200 may be varied according to requirements. In one embodiment, for example, a height of the tower member 202 is approximately 12 metres, a length of the transverse member 204 is approximately 27 metres, a height of the rotatable connector 210 is approximately 4 metres, a length of the side member 206 is approximately 9 metres.

A method of operating a cargo transfer system 200 is described in the following paragraphs. It is to be appreciated that the method may be modified, and some steps may be interchanged or omitted in certain embodiments of the invention.

To deploy the cargo transfer system, the first deck 110 and the second deck 120, e.g. floating platform and container vessel, may be disposed in proximity such that they are at an appropriate distance from each other, e.g. approximately 12 metres apart. The floating platform and container vessel may be secured in position using fixed connectors, mooring systems or other appropriate anchor system.

After the first deck 110 and the second deck 120 are appropriately positioned, the cargo transfer system 200 may then be manipulated or moved from a stowed position (FIG. 4) to a deployment position (FIG. 3). For this purpose, the transverse member 204 may be manipulated to extend towards the second deck 120 since the cargo transfer system 200 is installed on the first deck 110. More particularly, the transverse member 204 may be lifted by a lifting cable 312 attached thereto and progressively swung away from the first deck 110 towards the second deck 120, using a gear mechanism or other appropriate mechanism, until the side member 206 becomes proximate to a receiving base 220 on the second deck 120.

The side member 206 may then be manipulated to engage with the receiving base 220, more specifically, to couple to a movable member 224 of the receiving base 220, to render the system in a deployment position. More particularly, if desired, the movable member 224 may be secured at one of the connectable positions provided by the receiving base 220. It is to be appreciated that the corresponding steps in reverse sequence may be performed when the system is to be folded back for stowage. It is also to be appreciated that the deployment, stowage and container transfer operations of the system may be fully automated, manually (by one or several persons) or semi-manually operated.

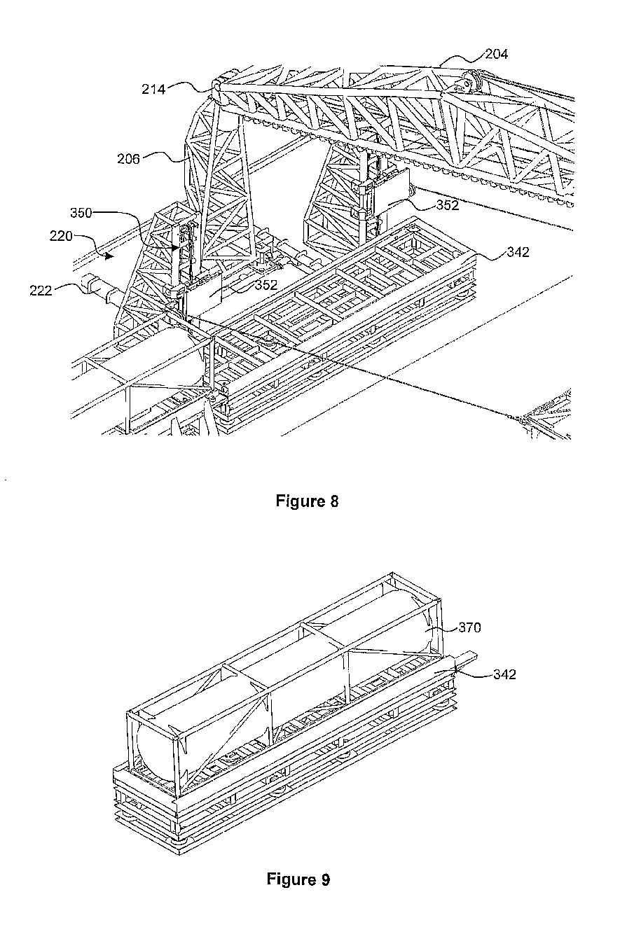

Transfer of cargo containers 320 between the first deck 110 and the second deck 120 is performed using the carriage 320 and the cargo connector device 330 to lift a cargo container and to move the cargo container 370 to the destination (see FIG. 9). More particularly, the cargo connector device 330 may be lowered onto the top of a cargo container 370 for connecting thereto. The cargo container 370 may be secured to the cargo connector device 330 and lifted from the first deck 110. In one embodiment, the cargo container 370 may be disposed on a damping platform 342 and as the cargo container 370 is being lifted from the first deck 110, a movable guide 352 (such as that described in the “catch-and-guide” system as above) may guide to the cargo container 370 to prevent excessive swinging movement. In another embodiment, depending on the current location of the cargo connector device 330 relative to the transverse member 204, the cargo container 370 may be raised or lowered to meet the cargo connector device 330, thus reducing or removing the need to lower the cargo connector device 330.

After the cargo container 370 is secured to the cargo connector device 330, the cargo container 370 is transported or moved along the length of the transverse member 204 towards the second deck 120. A suitable driving or actuation system may be employed for this purpose. Taglines, which may have been secured to the cargo connector device, may restrain the cargo container 370 while the cargo container 370 is transported towards the second deck 120. This would reduce lateral or swinging movement of the cargo container 370.

Upon reaching the second deck 120, the cargo container 370 may be lowered onto the second deck 120 or a designated damping platform 342. As the cargo container 370 is being lowered, a movable guide 352 may guide the cargo container to reduce lateral or swinging movement. After the cargo container is offloaded, the cargo container 370 may be transported to a storage location or other desired location. While the above describes cargo transfer from a first deck 110 to a second deck 120, cargo transfer in the reverse direction may be performed in a similar manner with suitable modifications.

Embodiments of the cargo transfer system 200 is capable of countering relative dynamic motions of the first 110 and the second deck 120 using the aforementioned features (i.e. pivotable and rotatable connectors) which provide multiple, e.g. six, independent DOF capabilities: (A) rotatable connector 210 allowing rotational movement of the transverse member 204 about the longitudinal axis of the tower member 202, (B) first pivotable connector 212 allowing relative pivotal movement between the transverse member 204 and the tower member 202 (in a plane perpendicular to the first deck 110), (C) rotating of the side member 206 about the longitudinal axis of the transverse member 204, (D) second pivotable connector 214 allowing relative pivotal movement between the side member 206 and the transverse member 204, (E) rotating of the transverse member 204 about the longitudinal axis of the side member 206 and, (F) third pivotal connector 216 allowing relative pivotal movement between the side member 206 and the second deck 120. The above rotational and pivotal motions (see arrows A to F in FIG. 9) combine in such a way as to accommodate any relative movements between the decks 110 and 120, while at all times maintaining a stable system via which cargo containers can be transferred. For certain embodiments of the invention where particular motions are not substantial, some of the above connectors could be removed or simplified to provide a more limited range of motion suitable for a given task and environment.

Dynamic motions (e.g. relative surge, relative sway, and relative heave, respectively represented by FIGS. 12 to 14), caused by environmental loads, generally involve a change in both translational and rotational motions on the vessels. Depending on the type(s) of dynamic motions experienced, the system self-adjusts via at least one of or a combination of the above-described motions and movable connections (A to F). The self-adjustment of at least one of the movable connections (A to F) or at least one of the transverse member 204 and side member 206 relative to each other is actuated by a relative movement between the first deck 110 and the second deck 120. In certain embodiment, the cargo transfer system 200 may permit a relative motion variation of up to about ±2.5 metres in any direction in one embodiment of the invention. It is to be appreciated that the ability of the system to accommodate relative motion variation may be increased or decreased with appropriate modification to the cargo transfer system.

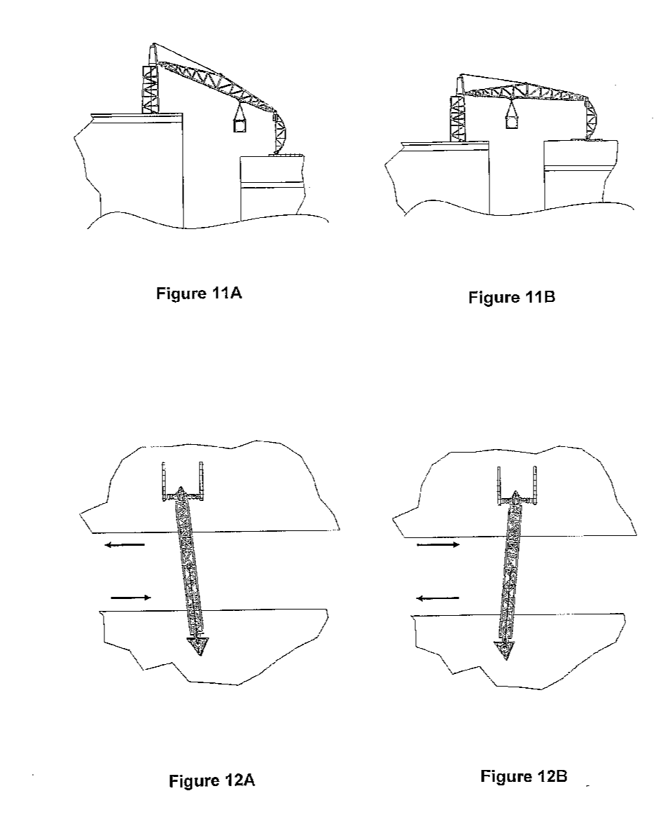

In addition to the above range of dynamic motions, operation of the system 200 may be extended by connecting the side member 206 to a receiving base 220 on a second deck 120 to allow operation of the system over a range of relative mean positions (static positions) between the first deck 110 and second deck 120. Examples of relative mean positions may be represented by FIGS. 11A and 11B. A change in a relative mean position caused by vessel drafts for example, generally involves a change in the relative height of the first deck 110 and second deck 120 while the spacing therebetween may remain substantially unchanged. This change may occur slowly over a long time period and may be accommodated by periodically adjusting a location of an effective coupling between the side member 206 and the second deck 120. In one embodiment of the invention, the static adjustment allows the freeboard of the first deck 110 to vary between 5 metres and 15 metres, and the second deck 120 to vary between 5.7 metres and 8 metres. This results in a range of relative deck heights of −9 metres to +3 metres.

In FIGS. 11A and 11B where a location of an effective coupling between the side member 206 and the second deck 120 is adjusted (or a position of the movable member 224 of the receiving base 220 is adjusted), one or more of the connectors (A to F) may also be self-adjusted in order to accommodate a change in a relative mean position between the first deck 110 and the second deck 120.

In one embodiment, it is estimated that the system may have an average transfer rate of 360 containers in 24 hours (i.e. a processing time of approximately 4 minutes per container).

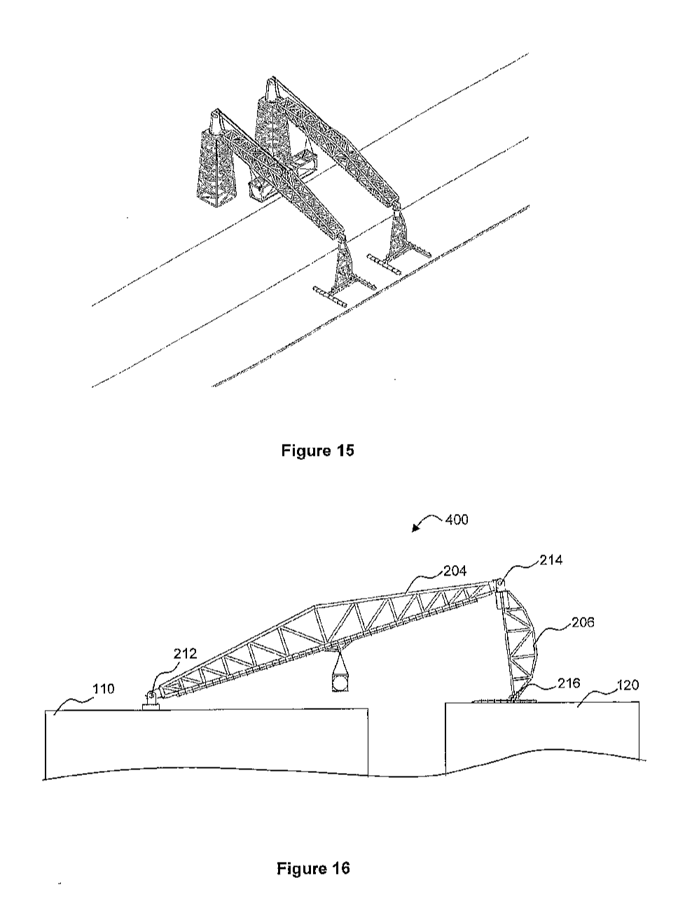

In the embodiment illustrated in FIG. 3, a single transverse member 204 is manipulated to transfer a cargo container between the first deck 110 and the second deck 120. In another embodiment as illustrated in FIG. 15, two transverse members are simultaneously manipulated to transfer a cargo container between the decks 110, 120. This may be useful in very heavy or longer cargo. In the embodiment of FIG. 15, the cargo connector device is connected to the cargo container and supported by two carriages running along the two transverse members. A control system may be required to ensure that the carriages on the two transverse members function in cooperation to facilitate a stable transfer of cargo containers between the first deck 110 and the second deck 120.

In the embodiment illustrated in FIGS. 2 to 15, a transfer system 200 comprises three primary members or arms: a tower member 202, a main transfer member (or a transverse member 204) and a side member 206. The tower member 202 is used to elevate a rotatable connector 210 from a first deck 110 whereby the rotatable connector 210 is coupled to the transverse member 204. Embodiments that include a tower member 202 or an elevated portion may be used in some cases where generally bulky cargo is to be handled and lifted from the deck. The height of the tower member 202 or elevated portion would vary depending on the specific application. However in certain other embodiments, a tower member 202 may not be required.

In one embodiment of a cargo transfer system 400 as illustrated in FIG. 16, the transverse member 204 may be movably coupled directly to a first deck 110 via a pivotable connector 212 which is mounted on the first deck 110. Both the pivotable connectors 214, 216 as described above may be used in this embodiment. The receiving base 220 may also be used in this embodiment in similar manner described above. In addition, it is to be appreciated that certain modifications may be made to the embodiment of FIG. 16 if required. For example, a carriage provided on the transverse member 204 to transport a connecting device (which is to support a cargo container) along the transverse member 204 may be appropriately configured, with appropriate modifications to the side member 206, to further transport the cargo connector device along the side member 206. When the cargo transfer system 400 is in a deployment position, at least one of the transverse member 204 and the side member 206 is actuatable, by a relative movement between the first deck 110 and the second deck 120, to self-adjust for accommodating the relative movement.

Embodiments of the cargo transfer system may be suitably designed and modified to handle different load capacities. In one embodiment, the system may be designed to handle tank containers for gas or liquid storage measuring 12.192 metres (length) by 2.438 metres (width) by 2.591 metres (height). The tank containers comply with the ISO size requirements for 40 foot containers typically weighing up to 30 tonnes. Alternatively, the system may also handle conventional 20, 40 or 45 foot ISO size compliant containers. Yet alternatively, the system may also handle other types of containers used for cargo transportation. Suitable structural modifications may be made to the system in order to handle different sizes containers which may be larger and heavier.

Other embodiments will be apparent to those skilled in the art from consideration of the specification and practice of the invention. Furthermore, certain terminology has been used for the purposes of descriptive clarity, and not to limit the embodiments as disclosed. The embodiments and features described above should be considered exemplary, with the invention being defined by the appended claims.

1-25. (canceled)

26. A cargo transfer system comprising:
a tower member disposed on a first deck;
a transverse member pivotally and rotatably coupled to the tower member for allowing rotation of the transverse member in a vertical plane and a horizontal plane both about an elevated portion of the tower member;
a side member disposed below the transverse member, the side member having a first end pivotally coupled to the transverse member, and a second end operable to pivotally couple to a second deck which is disposable over a plurality of relative mean positions including the second deck being displaced above the first deck, the second deck being displaced below the first deck and the second deck being disposed at a similar elevation as the first deck,
wherein the transverse member and the side member are actuatable, by a relative movement between the first deck and the second deck, to self-adjust for accommodating the relative movement; and
a carriage movable along the transverse member for transferring a cargo from the first deck to the second deck, or vice versa.

27. The system of claim 26, further comprising:
a first connector for rotatably coupling a first end of the transverse member to the elevated portion of the tower member; and
a second connector provided at the first connector for pivotally coupling the first end of the transverse member to the elevated portion of the tower member.

28. The system of claim 26, wherein the tower member forms an integral part of the first deck.

29. The system of claim 27, wherein the side member is rotatable about a longitudinal axis of the transverse member, and the transverse member is rotatable about a longitudinal axis of the side member.

30. The system of claim 29, wherein the tower member, the transverse member and the side member are arranged to provide the cargo transfer system with six degrees of freedom of motion.

31. The system of claim 26, further comprising:
a receiving base mounted on the second deck, the receiving base providing a plurality of connectable positions for accommodating the plurality of relative mean positions between the first deck and the second deck, wherein a location of an effective coupling between the second end of the side member and the second deck is adjustable between the plurality of connectable positions.

32. The system of claim 31, wherein the receiving base further includes a movable member adjustable between the plurality of connectable positions, the movable member for pivotally coupling the second end of the side member thereto in a deployment position.

33. The system of claim 32, wherein the receiving base further includes a lock mechanism for securing the movable member at one of the plurality of connectable positions.

34. The system of claim 26, wherein the second end of the side member is operable to release from the second deck when the relative movement between the first deck and the second deck exceeds a predetermined level.

35. The system of claim 26, further comprising a pulley system attached to the member for transverse member for lifting the transverse member and the side member to allow a a movement of the transverse member and the side member from a stowed position to a deployment position, or vice versa.

36. The system of claim 26, further comprising a vertical damping system for reducing impact to the cargo, and a horizontal damping and guiding system for restricting a lateral movement of the cargo during onloading and offloading.

37. The system of claim 26, further comprising a tag-line system for restricting a lateral movement of the cargo during transfer of the cargo.

38. A method of cargo transfer, the method comprising:
disposing a first deck, having a tower member disposed thereon, and a second deck in proximity, wherein a transverse member is pivotally and rotatably coupled to the tower member for allowing rotation of the transverse member in a vertical plane and a horizontal plane both about an elevated portion of the tower member, and a side member is disposed below the transverse member and pivotally coupled to the transverse member;
pivotally coupling the side member to the second deck;
allowing disposal of the second deck over a plurality of relative mean positions including the second deck being displaced above the first deck, the second deck being displaced below the first deck and the second deck being disposed at a similar elevation as the first deck;
transferring a cargo from the first deck to the second deck, or vice versa, along the transverse member; and
self-adjusting the transverse member and the side member for accommodating a relative movement between the first deck and the second deck, wherein the self-adjusting is actuatable by the relative movement between the first deck and the second deck.

39. The method of claim 38, wherein disposing a first deck, having a tower member therein, and a second deck in proximity further includes having a first connector for rotatably coupling a first end of the transverse member to the elevated portion of the tower member and a second connector provided at the first connector for pivotally coupling the first end of the transverse member to the elevated portion of the tower member.

40. The method of claim 38, wherein disposing a first deck, having a tower member disposed thereon, and a second deck in proximity further includes having the tower member as an integral part of the first deck.

41. The method of claim 39, wherein disposing a first deck, having a tower member disposed thereon, and a second deck in proximity further includes having the side member rotatable about a longitudinal axis of the transverse member, and the transverse member rotatable about a longitudinal axis of the side member.

42. The method of claim 38, wherein pivotally coupling the side member to the second deck further includes pivotally coupling the side member to a receiving base mounted on the second deck, the receiving base providing a plurality of connectable positions for accommodating the plurality of relative mean positions between the first deck and the second deck, wherein a location of an effective coupling between the side member and the second deck is one of the plurality of connectable positions.

43. The method of claim 42, further comprising: adjusting the location of the effective coupling to another one of the plurality of connectable positions for accommodating a change in a relative mean position between the first deck and the second deck.

44. The method of claim 42, wherein pivotally coupling the side member to a receiving base mounted on the second deck further includes pivotally coupling the side member to a movable member of the receiving base, the movable member being adjustable between the plurality of connectable positions.

45. The method of claim 44, further comprising: securing the movable member at one of the plurality of connectable positions.

46. The method of claim 38, further comprising: releasing the side member from the second deck when the relative movement between the first deck and the second deck exceeds a predetermined level.
